(19) United States
(12) Patent Application Publication
(10) Pub. No.: US 2009/0172063 A1
(43) Pub. Date: Jul. 2, 2009

(54) Multi-Threaded Codeless User-Defined Functions

(75) Inventors: Joseph M. Chirilov, Redmond, WA (US); Jeffrey J. Duzak, Redmond, WA (US); Andrew J. Becker, Duvall, WA (US); Charles D. Ellis, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/964,497

(22) Filed: Dec. 26, 2007

(51) Int. Cl. G06F 7/38; G06F 7/00

(52) U.S. Cl. 708/441; 708/200

(57) ABSTRACT

A multi-threaded codeless user-defined function (UDF) may be provided. First, at least one input value may be received from a calculation thread corresponding to a spreadsheet calling the codeless UDF. Then, the at least one input value may be saved in a thread storage area outside of a UDF storage area containing the codeless UDF. Next, the codeless UDF may be performed comprising performing at least one calculation using at least one formula in the codeless UDF and the at least one input value from the thread storage area. At least one output value produced in response to performing the codeless UDF may then be returned to the calculation thread corresponding to the spreadsheet calling the codeless UDF.

### BACKGROUND

In accounting, a spreadsheet is a large sheet of paper with columns and rows that organizes data regarding transactions for a person to examine. The spreadsheet shows, for example, costs, income, taxes, or other related data on a single sheet for a manager to examine when making a decision.

Spreadsheets have been computerized into “electronic spreadsheets.” An electronic spreadsheet organizes information into software defined columns and rows. The information in the electronic spreadsheet, for example, can then be “added up” by a formula to give a total. A computer program running the electronic spreadsheet summarizes information from many sources in one place and presents the information in a given format. The electronic spreadsheet helps a decision maker see the financial “big picture” for an organization.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A multi-threaded codeless user-defined function (UDF) may be provided. First, at least one input value may be received from a calculation thread corresponding to a spreadsheet calling the codeless UDF. Then, the at least one input value may be saved in a thread storage area outside of a UDF storage area containing the codeless UDF. Next, the codeless UDF may be performed comprising performing at least one calculation using at least one formula in the codeless UDF and the at least one input value from the thread storage area. At least one output value produced in response to performing the codeless UDF may then be returned to the calculation thread corresponding to the spreadsheet calling the codeless UDF.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a diagram illustrating a codeless UDF spanning a portion of a spreadsheet;

FIG. 3 is a diagram illustrating a spreadsheet that may call a codeless UDF;

FIG. 4 is a flow chart of a method for providing multi-threaded codeless user-defined functions;

FIG. 5 is a diagram illustrating a codeless UDF spanning a portion of a spreadsheet;

FIG. 6 is a diagram illustrating a per-UDF data structure;

FIG. 7 is a diagram illustrating a per-call data structure;

FIG. 8 is a diagram illustrating a per-cell data structures for a normal curve UDF; and

FIG. 9 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

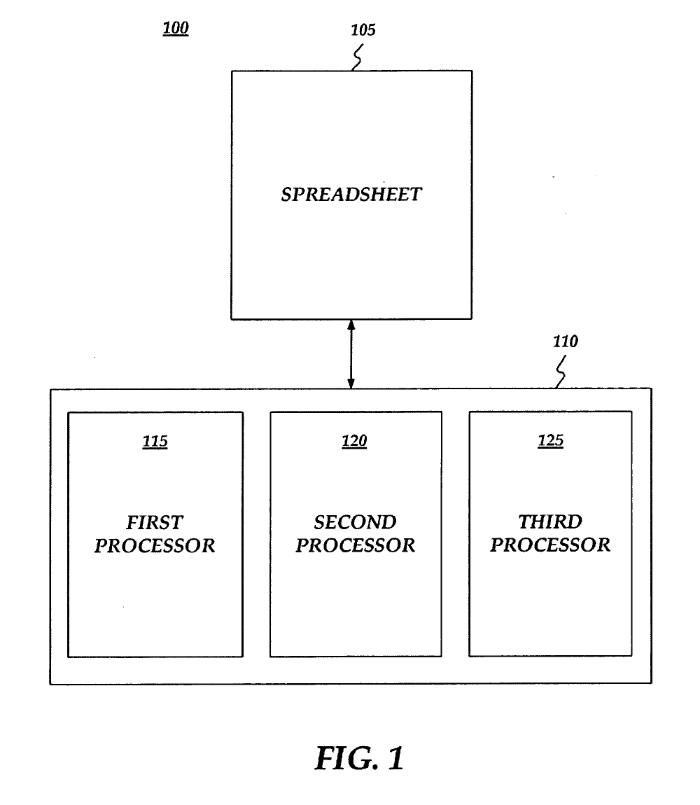

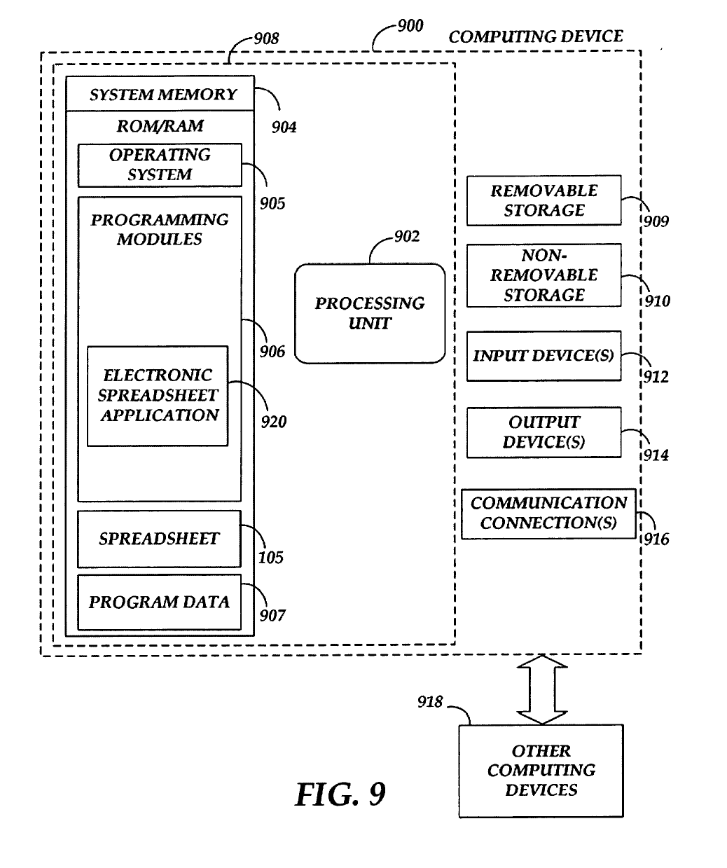

FIG. 1 shows a spreadsheet calculation system 100 for calculating a spreadsheet 105 over multi-processors 110. For example, an electronic spreadsheet application (e.g. an electronic spreadsheet application 920 as described in more detail below with respect to FIG. 9) may organize data into cells defined by columns and rows. A user may cause the data to be acted upon, for example, by a formula to give a desired result. Some formulas (i.e. standard functions) available to the user may be defined by the electronic spreadsheet application's developer. In addition to standard functions, the electronic spreadsheet application's developer may allow for codeless user-defined functions (UDFs). Consistent with embodiments of the invention, a codeless UDF may comprise a feature wherein the user can encapsulate, in a single function (e.g. defined by the user), a model that may span a large cell area in spreadsheet 105. The codeless UDF may comprise or otherwise include standard functions provided by the electronic spreadsheet application's developer and may include calls to other UDFs as well. When defining a codeless UDF, the user may specify a spreadsheet portion that may encompass the model, as well as input cell and output cell locations. The function may then be called, for example, from any other formula.

Multi-threaded calculation, consistent with embodiments of the invention, may comprise a feature wherein computing work that performs a spreadsheet's calculations is divided among multiple processors (e.g. multi-processors 110). This division may allow each processor (e.g. a first processor 115, a second processor 120, and a third processor 125) to perform some computing work portion. By dividing the computing work among multi-processors 110, spreadsheet 105 may be calculated in less time than with a single processor. Furthermore, multi-threaded calculation may place restrictions on any functionality that may be performed during the spreadsheet calculation. For example, a multi-threaded calculation may be “thread-safe.” A thread-safe multi-threaded calculation may not interfere with other processors in the multiple processors performing same or different tasks. Consistent with embodiments of the invention, codeless UDFs may function when running during multi-threaded calculations. Moreover, embodiments of the invention may include additional elements including an ARGUMENT function and vectorization support as described in more detail below.

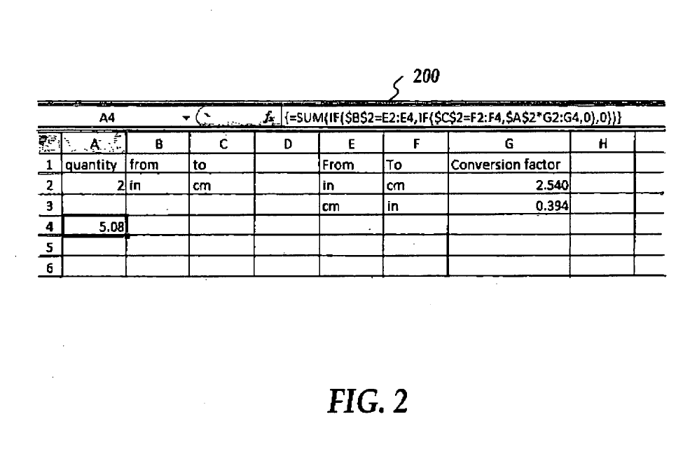

FIG. 2 illustrates a codeless UDF spanning a portion of a spreadsheet 200 specified by, for example, a user along with specified input and output cells. The example codeless UDF of FIG. 2 may convert quantities from one unit system to another. As shown in FIG. 2, the user may specify that the codeless UDF is contained in the range A1:G4, or may specify that the codeless UDF comprises this entire spreadsheet. The user may specify A2, B2, and C2 as input cells, and A4 as the output cell. The other cells in the example codeless UDF of FIG. 2 may comprise a “calculation mode” for the codeless UDF. The user may name FIG. 2's codeless UDF “CONVERT.”

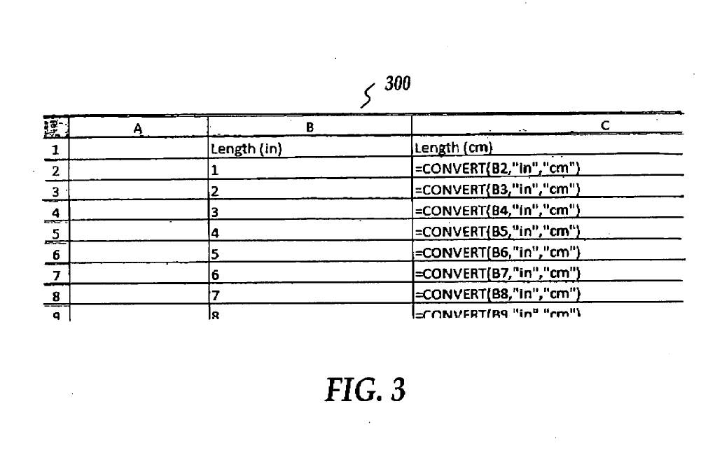

FIG. 3 shows a spreadsheet 300 that may call the codeless UDF defined in FIG. 2. As shown in FIG. 3, outside of the codeless UDF range illustrated in FIG. 2, on another sheet for example, the user may enter several formulas using the “CONVERT” UDF defined above with respect to FIG. 2. While executing spreadsheet 300, spreadsheet application 920 may manipulate data in spreadsheet 200's input cells when spreadsheet 300 calls the codeless UDF defined in FIG. 2. However, when finished with spreadsheet 200, spreadsheet application 920 may place spreadsheet 200 back to the state in which it was found prior to manipulating the data in spreadsheet 200's input cells. In addition, there may be many calls to the CONVERT UDF. Because electronic spreadsheet application 920 may provide multi-threaded calculation, several of the calls to the CONVERT UDF may be evaluated simultaneously. Consequently, the several simultaneous calls should not interfere with each other.

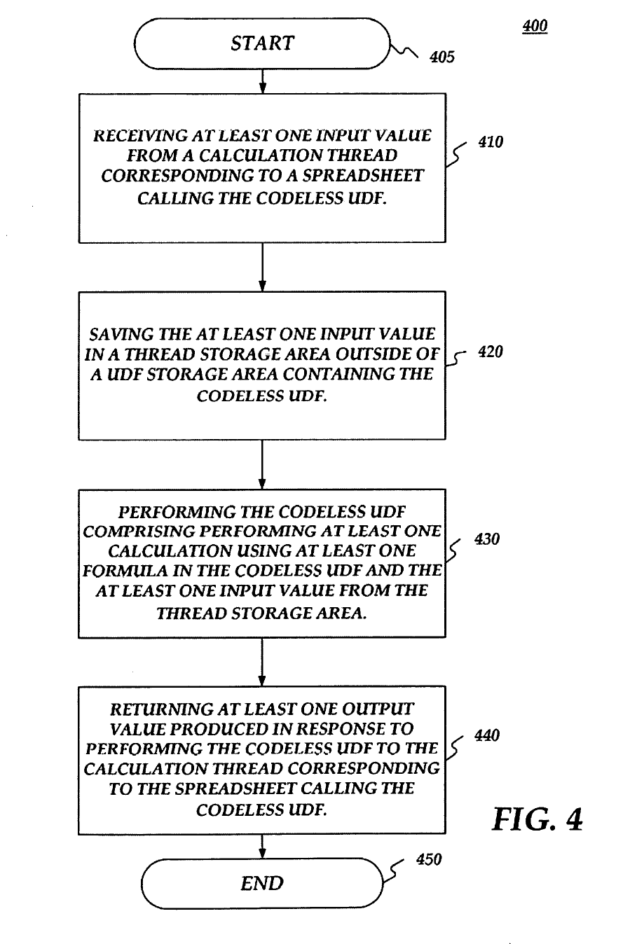

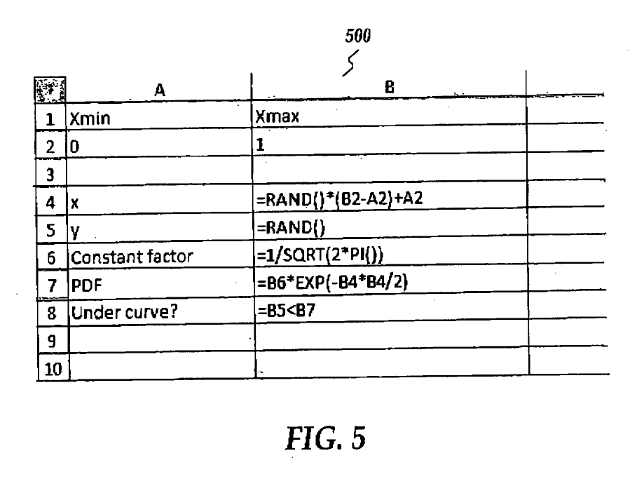

FIG. 4 is a flow chart setting forth the general stages involved in a method 400 consistent with embodiments of the invention for providing multi-threaded codeless UDFs. Method 400 may be implemented using a computing device 900 as described in more detail below with respect to FIG. 9. Ways to implement the stages of method 400 will be described in greater detail below. Method 400 may begin at starting block 405 and proceed to stage 410 where computing device 900 may receive at least one input value from a calculation thread corresponding to a spreadsheet (e.g. spreadsheet 105) calling the codeless UDF. For example, in order to execute a codeless UDF (e.g. the codeless UDFs of FIG. 2 or FIG. 5), electronic spreadsheet application 920 may: i) put input values from a caller of the codeless UDF in input cells of the codeless UDF; ii) calculate all formulas in the codeless UDF area that depend (e.g. directly or indirectly) on the codeless UDF's input cells; and iii) take a value from an output cell of the codeless UDF and return the output cell value to the caller of the codeless UDF.

From stage 410, where computing device 900 receives the at least one input value, method 400 may advance to stage 420 where computing device 900 may save the at least one input value in a thread storage area outside of a UDF storage area containing the codeless UDF. For example, because it may not be desirable to overwrite the actual values already in the codeless UDF's input cells, instead of placing the input values directly in the codeless UDF's input cells (e.g. the UDF storage area), embodiments of the invention may instead store these input values in a separate location (e.g. the thread storage area) where spreadsheet application 920 may know to look for them when they are needed. Further, because the codeless UDF may be executed several times at once with different inputs on separate threads during multi-threaded calculation, there may be multiple storage locations for these inputs, for example, one per calculation thread. When spreadsheet application 920 needs to look up the value of an input cell, spreadsheet application 920 may be able to determine from which storage location to take the value.

Once computing device 900 saves the at least one input value in stage 420, method 400 may continue to stage 430 where computing device 900 may perform the codeless UDF comprising performing at least one calculation using at least one formula in the codeless UDF and the at least one input value from the thread storage area. For example, in order to calculate all formulas in the codeless UDF area that depend, directly or indirectly, on the input cells as referenced above, spreadsheet application 920 may need to know which formulas to calculate. FIG. 5 illustrates a codeless UDF spanning a portion of a spreadsheet 500 specified by, for example, a user to calculate the area under a portion of the normal curve. As shown in spreadsheet 500, the input cells may be A2 and B2, the output cell may be B8, and the user may have specified that the UDF spans entire spreadsheet 500. Other cells in spreadsheet 500 may comprise a “calculation mode” for spreadsheet 500. However, cell B6 may not depend on any input cell. Consequently, there may be no reason to calculate B6 every time that the UDF of FIG. 5 is invoked. Likewise, B5 may not depend on any input cell, but may include the volatile “RAND” function. Because it is volatile, spreadsheet application 920 may recalculate the RAND function every time the UDF of FIG. 5 is evaluated. Accordingly, a list of formulas that may be calculated when evaluating a UDF comprise all formulas in the UDF area that either: i) depend, directly or indirectly, on one or more input cells; or ii) are volatile, or depend on another volatile formula.

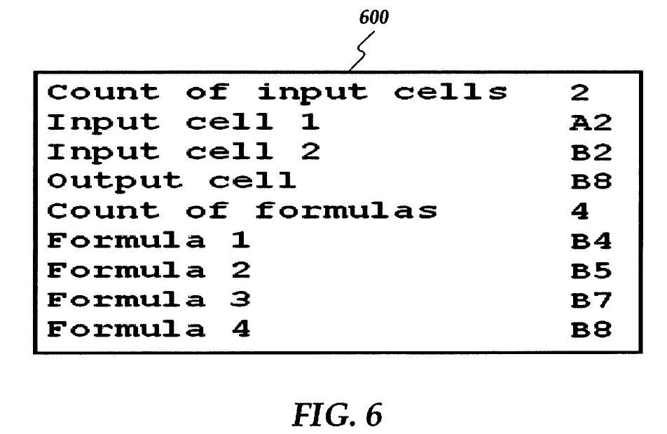

As shown in FIG. 5, the list of formulas that may be calculated when evaluating the UDF may include the formulas in cells B4, B5, B7, and B8. This list may be the same for every time FIG. 5's codeless UDF is evaluated. Consequently, this list may be stored in a data structure associated with this codeless UDF that may be created when the user defines the UDF and that may not change unless the user changes the definition of the UDF. There does not need to be separate copies of this structure for different calculation threads. The list of input cells and the output cell likewise may be stored in this data structure that may be called a per-UDF data structure. FIG. 6 illustrates a per-UDF data structure 600 for the normal curve UDF as described above with respect to FIG. 5.

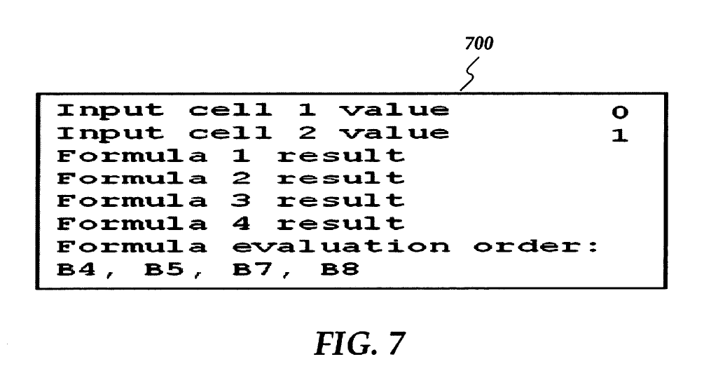

Moreover, the formulas in FIG. 5's codeless UDF may be evaluated in a certain order. For example, B4 and B5 may be evaluated before B7, which may be evaluated before B8. In certain circumstances (not in this example), the order that formulas may be evaluated may depend on the input values. For example, if two calculation threads are evaluating the same codeless UDF with different input values, it may be possible that they may need to evaluate the formulas in different orders. Therefore, the order in which the formulas may be evaluated is information that may be stored in a data structure owned by the thread that is evaluating the UDF call. This may be called a per-call data structure. FIG. 7 illustrates a per-call data structure 700 for the normal curve UDF as described above with respect to FIG. 5.

When formula evaluation calls for retrieving a value from a cell, a process may be used to know whether or not that cell is an input cell for or contains a formula that participates in the UDF, and if so, to know which input cell or which formula it is in relation to the UDF. For example, in the normal curve example as described above with respect to FIG. 5, B4 may refer to A2. When evaluating the formula in B4, spreadsheet application 920 may try to retrieve a value from A2. Because spreadsheet application 920 may need to know that A2 may be the first input cell for the UDF, instead of retrieving a value from the cell itself, spreadsheet application 920 may retrieve the first parameter passed into this particular call to the UDF. Consequently, when the UDF is created by a user, spreadsheet application 920 may create a per-cell data structure and link it to the actual cell. Like the per-UDF data structure, the per-cell data data structures may remain unchanged unless the user changes the definition of the UDF. Accordingly, there does not need to be separate instances of these data structures for each thread.

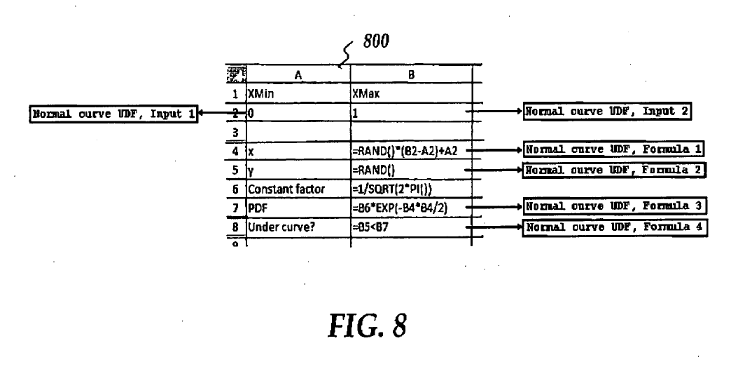

FIG. 8 illustrates a per-cell data structure 800 for the normal curve UDF example of FIG. 5. As shown in FIG. 8, when a calculation thread tries to retrieve the value from cell A2, it may see that A2 corresponds to the first input for the normal curve UDF. The thread may then check if it is currently evaluating the normal curve UDF, and if so, may retrieve the first input to the call, which is itself stored in the per-call data structure. If the thread is not currently evaluating the normal curve UDF, it may retrieve the value from the cell as normal. Once all the UDF's formulas have been calculated by spreadsheet application 920, the result may be obtained from the specified output cell. In the above normal curve example, the output cell may be B8. Upon retrieving the value from B8, spreadsheet application 920 may see that B8 corresponds to the fourth formula in the UDF and may consequently use the result stored in the per-call data structure for that formula.

After computing device 900 performs the codeless UDF in stage 430, method 400 may proceed to stage 440 where computing device 900 may return at least one output value produced in response to performing the codeless UDF to the calculation thread corresponding to the spreadsheet calling the codeless UDF. For example, spreadsheet application 920 may take a value from an output cell of the codeless UDF and return the output cell value to the caller of the codeless UDF. As a result, codeless UDF evaluation may be thread-safe because all data that may change during the UDF's evaluation may be stored in an instance of the per-call data structure that may be owned by the thread evaluating the UDF. No other thread may look at that data structure instance. If multiple threads are evaluating the same codeless UDF simultaneously, then each thread may have its own instance of the per-call data structure. Accordingly, none of the threads may interfere with any other thread. Furthermore, if there is another thread that is not evaluating the codeless UDF but needs to retrieve the value from a cell that participates in a codeless UDF, it may be able to retrieve the value directly from the cell. Again, the threads that are evaluating the codeless UDF may not interfere with threads that are not evaluating the UDF. Once computing device 900 returns the at least one output value in stage 440, method 400 may then end at stage 450.

Consistent with embodiments of the invention, in addition to using the specified input cells, codeless UDFs may have another way to retrieve arguments that were passed to a particular call to the UDF, an “ARGUMENT” function. For example, calling ARGUMENT(n) may retrieve the n^{th} argument to the UDF call. This may be useful because it may return arrays or cell references. Consequently, if only input cells are used to pass arguments, there may be no way to pass an array or cell reference to the UDF.

For example, a user may want to create a codeless UDF called “AREASIZE” that may take an area reference and return the count of cells in that area. Without the ARGUMENT function, it may not be impossible to create such a UDF. With the ARGUMENT function, the AREASIZE UDF may be created, for example, using the following formula:

=ROWS(ARGUMENT(1))*COLUMNS(ARGUMENT(1))

Consistent with embodiments of the invention vectorization may be provided. Vectorization may refer to the applying an operation individually to each member of an array. For example, consider the following array-entered formula:

{=SUM(SIN(A1:A10))}

Spreadsheet application 920 may perform a “SIN” function on each entry in the area A1:A10 and create an array that contains all of the results of these SIN functions. That array may then be passed to a “SUM” function that may aggregate the array and return a single value. Consequently, spreadsheet application 920 may perform vectorization if it knows that the operation in question is not intended to work on an array of values. For example, consider the following array-entered formula:

{=SUM(A1:A10)}

Spreadsheet application 920 may not call the SUM function once for each value in the range A1:A10, because spreadsheet application 920 may know that the SUM function may take arrays as arguments. Consequently, spreadsheet application 920 may only call the SUM function once and pass the entire array as an argument.

In order for codeless UDFs to take advantage of vectorization, there may be a way for the user creating the UDF to specify whether an argument can take arrays and area references or only individual values. For example, a codeless UDF that implements the hyperbolic SIN function (SINH) may specify that it takes only individual values, and therefore gets spreadsheet application 920's vectorization behavior. A codeless UDF that performs some kind of aggregation may specify that it takes arrays and area references, and therefore may not get spreadsheet application 920's vectorization behavior. Consistent with embodiments of the invnetion, codeless UDF may, upon UDF creation, allow the user to specify for each argument whether the argument can take arrays and area references or only individual values.

An embodiment consistent with the invention may comprise a system for providing a codeless user-defined function (UDF). The system may comprise a memory storage and a processing unit coupled to the memory storage. The processing unit may be operative to receive at least one input value from a calculation thread corresponding to a spreadsheet calling the codeless UDF. In addition, the processing unit may be operative to save the at least one input value in a thread storage area outside of a UDF storage area containing the codeless UDF. Moreover, the processing unit may be operative to perform the codeless UDF comprising performing at least one calculation using at least one formula in the codeless UDF and the at least one input value from the thread storage area. Also, the processing unit may be operative to return at least one output value produced in response to performing the codeless UDF to the calculation thread corresponding to the spreadsheet calling the codeless UDF.

Another embodiment consistent with the invention may comprise a system for providing a codeless user-defined function (UDF). The system may comprise a memory storage and a processing unit coupled to the memory storage. The processing unit may be operative to receive a plurality of input values respectively from a plurality of calculation threads corresponding to a spreadsheet calling the codeless UDF. Also, the processing unit may be operative to save the plurality of input values respectively in a plurality of thread storage areas. Each of the plurality of thread storage areas may be outside of a UDF storage area containing the codeless UDF. For each one of the plurality of input values, the processing unit may be operative to: i) retrieving an input value from the saved plurality of input values, ii) perform the codeless UDF comprising performing calculations using a plurality of formulas in the codeless UDF and the retrieved input value, and iii) return at least one output value produced in response to performing the codeless UDF to the calculation thread corresponding to the retrieved input value.

Yet another embodiment consistent with the invention may comprise a system for providing a codeless user-defined function (UDF). The system may comprise a memory storage and a processing unit coupled to the memory storage. The processing unit may be operative to save at least one input value in a thread storage area outside of a UDF storage area containing the codeless UDF. The at least one input value may correspond a calculation thread corresponding to a spreadsheet calling the codeless UDF. In addition, the processing unit may be operative to perform the codeless UDF comprising the processing unit being operative to perform at least one calculation using at least one formula in the codeless UDF and the at least one input value from the thread storage area. The processing unit being operative to perform the at least one calculation using the at least one formula may comprise the processing unit being operative to perform the at least one calculation using the at least one formula in response to the processing unit determining that the at least one formula is identified in a per-UDF data structure. The per-UDF data structure may identify formulas in the codeless UDF that have at least one of the following characteristics: depend directly on at least one input cell in the codeless UDF, depend indirectly on at least one input cell in the codeless UDF, is volatile, and depend on other volatile formula in the codeless UDF. The processing unit being operative to perform the codeless UDF may comprise the processing unit being operative to perform the codeless UDF in an order defined by a per-call data structure. Moreover, the processing unit may be operative to return at least one output value produced in response to the processing unit performing the codeless UDF to the calculation thread corresponding to the spreadsheet calling the codeless UDF.

FIG. 9 is a block diagram of a system including computing device 900. Consistent with an embodiment of the invention, the aforementioned memory storage and processing unit may be implemented in a computing device, such as computing device 900 of FIG. 9. Any suitable combination of hardware, software, or firmware may be used to implement the memory storage and processing unit. For example, the memory storage and processing unit may be implemented with computing device 900 or any of other computing devices 918, in combination with computing device 900. The aforementioned system, device, and processors are examples and other systems, devices, and processors may comprise the aforementioned memory storage and processing unit, consistent with embodiments of the invention. Furthermore, computing device 900 may comprise an operating environment for system 100 as described above. System 100 may operate in other environments and is not limited to computing device 900.

With reference to FIG. 9, a system consistent with an embodiment of the invention may include a computing device, such as computing device 900. In a basic configuration, computing device 900 may include at least one processing unit 902 and a system memory 904. Processing unit 902 (e.g. multi-processors 110) may comprise multiple processors (e.g. first processor 115, second processor 120, and third processor 125). Depending on the configuration and type of computing device, system memory 904 may comprise, but is not limited to, volatile (e.g. random access memory (RAM)), non-volatile (e.g. read-only memory (ROM)), flash memory, or any combination. System memory 904 may include operating system 905, one or more programming modules 906, and may include a program data 907 and spreadsheet 105. Operating system 905, for example, may be suitable for controlling computing device 900's operation. In one embodiment, programming modules 906 may include electronic spreadsheet application 920. Furthermore, embodiments of the invention may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910. Computer storage media may include volatile and nonvolatile, removable and non-removable media implemented in any method or technology for storage of information, such as computer readable instructions, data structures, program modules, or other data. System memory 904, removable storage 909, and non-removable storage 910 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, etc. Output device(s) 914 such as a display, speakers, a printer, etc. may also be included. The aforementioned devices are examples and others may be used.

Computing device 900 may also contain a communication connection 916 that may allow device 900 to communicate with other computing devices 918, such as over a network in a distributed computing environment, for example, an intranet or the Internet. Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 904, including operating system 905. While executing on processing unit 902, programming modules 906 (e.g. electronic spreadsheet application 920) may perform processes including, for example, one or more method 400's stages as described above. The aforementioned process is an example, and processing unit 902 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a codeless user-defined function (UDF), the method comprising:
receiving at least one input value from a calculation thread corresponding to a spreadsheet calling the codeless UDF;
saving the at least one input value in a thread storage area outside of a UDF storage area containing the codeless UDF;
performing the codeless UDF comprising performing at least one calculation using at least one formula in the codeless UDF and the at least one input value from the thread storage area; and
returning at least one output value produced in response to performing the codeless UDF to the calculation thread corresponding to the spreadsheet calling the codeless UDF.

2. The method of claim 1, further comprising determining that the at least one formula is identified in a per-UDF data structure.

3. The method of claim 2, wherein performing the at least one calculation using the at least one formula comprises performing the at least one calculation using the at least one formula in response to determining that the at least one formula is identified in the per-UDF data structure.

4. The method of claim 1, wherein performing the at least one calculation using the at least one formula comprises performing the at least one calculation using the at least one formula in response to determining that the at least one formula is identified in a per-UDF data structure wherein the per-UDF data structure identifies formulas in the codeless UDF that have at least one of the following characteristics: depend directly on at least one input cell in the codeless UDF, depend indirectly on at least one input cell in the codeless UDF, is volatile, and depend on other volatile formula in the codeless UDF.

5. The method of claim 1, wherein performing the codeless UDF comprises performing the codeless UDF in an order defined by a per-call data structure.

6. The method of claim 1, wherein performing the codeless UDF comprises performing the codeless UDF in an order defined by a per-call data structure, the per-call data structure being unique to the calculation thread.

7. The method of claim 1, wherein performing the codeless UDF comprises:
retrieving a value from a cell in the codeless UDF; and
using a per-cell data structure to determine one of the following: whether the cell is an input cell for the codeless UDF and whether the cell contains a formula that participates in the codeless UDF.

8. The method of claim 1, wherein performing the at east one calculation using the at least one formula comprises performing the at least one calculation using the at least one formula wherein the formula depends on one of the following: directly on at least one input cell of the codeless UDF and indirectly on at least one input cell of the codeless UDF.

9. The method of claim 1, wherein performing the codeless UDF comprises performing the codeless UDF including an ARGUMENT function.

10. The method of claim 1, wherein performing the codeless UDF comprises performing the codeless UDF including vectorization comprising applying an operation individually to each member of an array in the codeless UDF.

11. A computer-readable medium which stores a set of instructions which when executed performs a method for providing a codeless user-defined function (UDF), the method executed by the set of instructions comprising:
receiving a plurality of input values respectively from a plurality of calculation threads corresponding to a spreadsheet calling the codeless UDF;
saving the plurality of input values respectively in a plurality of thread storage areas, each of the plurality of thread storage areas being outside of a UDF storage area containing the codeless UDF; and
for each one of the plurality of input values,
retrieving an input value from the saved plurality of input values,
performing the codeless UDF comprising performing calculations using a plurality of formulas in the codeless UDF and the retrieved input value, and
returning at least one output value produced in response to performing the codeless UDF to a one of the plurality of calculation threads corresponding to the retrieved input value.

12. The computer-readable medium of claim 11, further comprising, for each one of the plurality of input values, determining that the plurality of formulas are identified in a per-UDF data structure.

13. The computer-readable medium of claim 12, wherein performing the calculations using the plurality of formulas comprises performing the calculations using the plurality of formulas in response to determining that the plurality of formulas are identified in the per-UDF data structure.

14. The computer-readable medium of claim 11, wherein performing the calculations using the plurality of formulas comprises performing the calculations using the plurality of formulas in response to determining that the plurality of formulas are identified in the per-UDF data structure wherein the per-UDF data structure identifies formulas in the codeless UDF that have at least one of the following characteristics: depend directly on at least one input cell in the codeless UDF, depend indirectly on at least one input cell in the codeless UDF, is volatile, and depend on other volatile formula in the codeless UDF.

15. The computer-readable medium of claim 11, wherein performing the calculations comprises performing the calculations in an order defined by a per-call data structure.

16. The computer-readable medium of claim 11, wherein performing the calculations comprises performing the calculations in an order defined by a per-call data structure, the per-call data structure being unique to the calculation thread corresponding to the retrieved input value.

17. The computer-readable medium of claim 11, wherein performing the calculations using the plurality of formulas in the codeless UDF comprises performing the calculations using the plurality of formulas in the codeless UDF wherein ones of the plurality of formulas depend on one of the following: directly on at least one input cell of the codeless UDF and indirectly on at least one input cell of the codeless UDF.

18. The computer-readable medium of claim 11, wherein performing the codeless UDF comprises performing the codeless UDF including an ARGUMENT function.

19. The computer-readable medium of claim 11, wherein performing the codeless UDF comprises performing the codeless UDF including vectorization comprising applying an operation individually to each member of an array in the codeless UDF.

20. A system for providing a codeless user-defined function (UDF), the system comprising:
a memory storage; and
a processing unit coupled to the memory storage, wherein the processing unit is operative to:
save at least one input value in a thread storage area outside of a UDF storage area containing the codeless UDF, the at least one input value corresponding a calculation thread corresponding to a spreadsheet calling the codeless UDF;
perform the codeless UDF comprising the processing unit being operative to perform at least one calculation using at least one formula in the codeless UDF and the at least one input value from the thread storage area wherein the processing unit being operative to perform the at least one calculation using the at least one formula comprises the processing unit being operative to perform the at least one calculation using the at least one formula in response to the processing unit determining that the at least one formula is identified in a per-UDF data structure wherein the per-UDF data structure identifies formulas in the codeless UDF that have at least one of the following characteristics: depend directly on at least one input cell in the codeless UDF, depend indirectly on at least one input cell in the codeless UDF, is volatile, and depend on other volatile formula in the codeless UDF, and wherein the processing unit being operative to perform the codeless UDF comprises the processing unit being operative to perform the codeless UDF in an order defined by a per-call data structure; and
return at least one output value produced in response to the processing unit performing the codeless UDF to the calculation thread corresponding to the spreadsheet calling the codeless UDF.
